(19) United States
(12) Patent Application Publication
(10) Pub. No.: US 2008/0243316 A1
(43) Pub. Date: Oct. 2, 2008

(54) Method For Setting an Aircraft Barometric Altitude

(75) Inventors: Jerome Sacle, Toulouse (FR); Francois Coulmeau, Seilh (FR)

Correspondence Address: LOWE HAUPTMAN & BERNER, LLP, 1700 DIAGONAL ROAD, SUITE 300, ALEXANDRIA, VA, 22314, US

(73) Assignee: Thales, Neuilly Sure Seine Cedex (FR)

(21) Appl. No.: 12/066,499

(22) PCT Filed: Oct. 24, 2006
(86) PCT No.: PCT/FR2006/002404

§ 371 Date: May 28, 2008

(30) Foreign Application Priority Data
Oct. 25, 2005 (FR) 05 10874

(51) Int. Cl. G06F 17/00

(52) U.S. Cl. 701/9

(57) ABSTRACT

The invention relates to a method for aiding the setting of the barometric altitude of an aircraft equipped with a means (11, 12) for determining the altitude not using the barometric pressure, determining with the aid of the means (11, 12) for determining the altitude an altitude (Zv, Zi, Zr, Zh) and its relative precision (Pzv, Pzr), comparing the determined altitude (Zv, Zi, Zr, Zh) with a barometric altitude measured aboard the aircraft, generating an alert when the discrepancy between the determined altitude (Zv, Zi, Zr, Zh) and the measured barometric altitude exceeds a predefined value and proposing a barometric altitude setting value.

### CROSS-REFERENCE TO RELATED APPLICATIONS

The present Application is based on International Application No. PCT/FR2006/002404, filed on Oct. 24, 2006, which in turn corresponds to French Application No. 05 10874, filed on Oct. 25, 2005, and priority is hereby claimed under 35 USC §119 based on these applications. Each of these applications are hereby incorporated by reference in their entirety into the present application.

### FIELD OF THE INVENTION

The invention relates to a method for aiding the setting of the barometric altitude of an aircraft.

### BACKGROUND OF THE INVENTION

The conduct of a flight requires the use of various settings of the barometric altitude. Departure and arrival take place in the low atmospheric layers using an altitude reference or local height reference to pinpoint the aircraft in the vertical plane. The remainder of the flight from climb to arrival use a standard altimetric reference facilitating inter-aircraft spacing. The change of altimetric reference is performed by a barometric setting operation for the altimeter during climb and descent. These operations are performed manually by the pilot requiring the knowledge of the local altimetric reference pressure in the low layers. This reference pressure is generally given relative to the mean sea level and will subsequently be called the QNH. Other references can also be used such as for example the pressure at the terrain level called the QFE.

The causes of altimetric setting errors can stem from erroneous acquisition of the reference pressure, its erroneous display on the altimeters or failure to perform the change of altimetric setting according to the phase of the flight.

The consequences of an erroneous altimetric setting are notably:
overflying of obstacles at a lower height than is prescribed by the procedure, reducing the crossing margin;
overflying of the obstacles at a greater height than is prescribed by an approach procedure, thereby giving rise to an erroneous approach plan that may involve difficulties in reducing the speed for final approach;
overflying of built-up areas at a lower height than is prescribed by the procedure, increasing sound nuisance.
transmission of erroneous altitude information from the aircraft to a control organization in charge of traffic information in air space not covered by a radar.
transmission of erroneous altitude information from the aircraft, to another aircraft during an inter-aircraft separation operation in an auto-information sector.
penetration into a restricted or forbidden area due to wrong reading of the altitude.

Additionally, aircraft appropriately equipped with onboard instruments may be induced to operate in geographical regions where ground assistance is very limited. For numerous isolated aerodromes in Africa, South America, Asia, the far North the local atmospheric pressure information is not available from an appropriate ground station.

The aspects of altimetric setting therefore have a direct impact on flight safety. A commonplace practice consists in the pilot of the aircraft, in the approach phase, interrogating the air traffic control of his arrival point regarding the value of the QNH. On receiving the information, the pilot manually modifies the setting of the onboard altimeter. This manual operation is a source of error both at the level of the understanding of the information received and the input to the altimeter.

### SUMMARY OF THE INVENTION

The invention is aimed at improving the reliability of the setting of the barometric altitude of an aircraft. For this purpose, the subject of the invention is a method for aiding the setting of the barometric altitude of an aircraft equipped with a means for determining the altitude not using the barometric pressure, characterized in that it consists in:
determining with the aid of the means for determining the altitude an altitude and its relative precision,
comparing the determined altitude with a barometric altitude measured aboard the aircraft,
generating an alert when the discrepancy between the determined altitude and the measured barometric altitude exceeds a predefined value.

The method in accordance with the invention is usable for all types of aircraft, military and civil, pertaining notably to business, regional and long-haul aviation.

The method is an aid for operating towards isolated airfields whose air traffic organization is not in post, thus making it possible to lower the approach minima. The decision altitude for certain approaches can vary according to the knowledge or otherwise of the local atmospheric pressure. For geographical areas where the QNH is available, the method is then a means of verifying the altimetric setting in the approach phase.

The method ensures an alert when the altitude determined appears unambiguously different from the altitude measured by barometric means which is dependent on the QNH displayed by the pilot. The method allows the semi-automatic setting of the QNH during the approach after pilot confirmation. The method can ensure automatic setting without outside intervention for example in the case of pilotless aircraft called drones.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 represents various approach flight phases;

FIG. 2 represents a flight plan comprising waypoints;

FIG. 3 represents a device making it possible to implement the invention;

FIG. 4 represents in block diagram form an exemplary chaining of the operations of the method of the invention.

For the sake of clarity, the same elements will bear the same references in the various figures.

### DETAILED DESCRIPTION OF THE PREFERRED EMBODIMENT

FIG. 1 represents as a broken line the trajectory 1 of an aircraft 2 in the approach to a runway 3 situated at an altitude Zp relative to sea level 4. The aircraft is equipped with two means for determining the altitude not using the barometric pressure, such as satellite navigation means, a GPS system for example, as well as radio altimetry means. The latter means have a limited range. They cannot perform measurement beyond 2500 feet or indeed 4000 feet for recent radio altimetry means. It is recalled that a foot equals 0.33 m. Subsequently in the description the altitudes will be expressed in feet as customary in the aeronautical sector. In a first phase \textcircled{1} of flight, beyond the range of the radio altimetry means, only the GPS system makes it possible to determine the altitude as a complement of means for measuring the barometric pressure, means also present aboard the aircraft. The GPS system determines the altitude of the aircraft as well as the precision with 95% certainty as a function of the signals received from the satellites of the GPS constellation. The precision is for example 45 feet when the signal received is of monofrequency type without jamming. The precision is 20 feet when the signal received is of bi-frequency type without jamming. The bi-frequency transmission mode is undergoing deployment at the date of filing of the present patent application. The GPS receiver on board the aircraft can determine a vertical level of precision that is well known in the literature by the name “vertical figure of merit (VFOM)”.

The method in accordance with the invention converts the altitude determined by the GPS system into a determined barometric altitude. The altitude is determined by the GPS system in its own inherent reference frame called WGS84. It is advantageous to change reference frame and to determine the altitude relative to the mean sea level. It is possible for example to use the “Geoid” reference frame. The change of reference frame can be done by means of a matrix available in the aeronautical literature. Advantageously, the altitude determined by the GPS system is corrected as a function of temperature so as to obtain a corrected barometric altitude. An exemplary correction is given by the following formula:

Zv/Zi=Tr/Tstd

where Zv represents the altitude determined by the GPS system, Zi represents the corrected determined barometric altitude, Tr represents the static temperature measured by the aircraft, and Tstd represents the standard temperature at the altitude considered. The standard temperature at sea level is 288 K from which is subtracted 2 K per 1000 feet of altitude. The temperature correction formula presented above is a simplified formula. Other formulae exist and allow better refinement of the correction.

The aircraft is equipped with means for measuring the barometric altitude. According to the invention, the altitude Zi determined by the GPS system is compared with a measured barometric altitude, and an alert is generated when the discrepancy between the altitude Zi and the measured barometric altitude exceeds a predefined value, advantageously dependent on the precision of the measurement carried out by the GPS system.

Thereafter, the method determines the correction to be made to the setting of the barometric altitude, for example expressed as QNH. More precisely, the method converted the difference between the altitude Zi and the measured barometric altitude into a pressure expressed in hPa. When the aircraft is in the low layers of the atmosphere, up to an altitude of about 1000 feet, it is possible to perform the conversion as a function of the equivalence of one hPa for 28 feet. At higher altitude, it is possible to use a more precise chart available in the aeronautical literature.

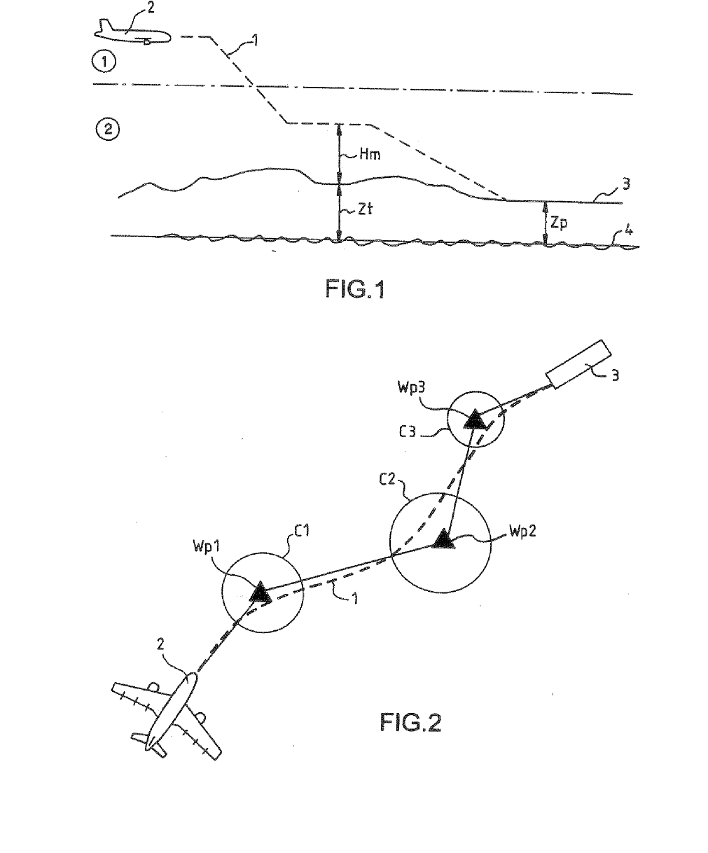

FIG. 2 makes it possible to illustrate a second phase \textcircled{2} of flight, at a lower altitude than that of the first phase \textcircled{1}. The aircraft can use these radio altimetry means to determine another value Zr of its altitude. More precisely, the radio altimetry means measure a height Hm relative to the ground and adds thereto the altitude of the terrain Zt at the point considered to obtain the altitude Zr. The altitude of the terrain Zt is determined on the basis of a terrain database and of the lateral position of the aircraft determined for example by the GPS system or by any other means such as for example an inertial platform and a flight computer with which the aircraft is equipped. It is possible to use a database on board the aircraft. This base is precise, reliable and compact. It relates notably to waypoints envisaged in the flight plan. In FIG. 2, three waypoints Wp1, Wp2 and Wp3 are represented, generically called Wpi subsequently. The flight plan of the aircraft 2 is represented as a solid line. The real trajectory 1 of the aircraft 2 is represented as a dashed line. Generally, the aircraft 2 does not pass exactly above the waypoints and usually, the aircraft anticipates its banks. The onboard database makes it possible to ascertain the altitude Zt at the waypoint Wpi considered as well as a circular area Ci centered on the waypoint Wpi and inside which the terrain altitude does not differ by more than 5% from the altitude Zt of the waypoint Wpi. The onboard database can express the altitude in the reference frame WGS84 used by the GPS system. Advantageously, a mean is calculated over several measurements of the altitude Hm so long as the aircraft is overflying the circular area Ci thereby making it possible to minimize any altitude error due to a lack of precision in the knowledge of the lateral position of the aircraft 2.

Just as for the GPS system, the altitude Zr determined by the radio altimetry means is converted into a determined barometric altitude with a possible change of reference frame and a temperature correction to obtain a corrected determined barometric altitude.

Thereafter, the altitude determined by the radio altimetry means is compared with a measured barometric altitude, and an alert is generated when the discrepancy between the radio altimetric altitude and the measured barometric altitude exceeds a predefined value, advantageously dependent on the precision of the measurement carried out by the radio altimetry means.

Additionally, it is possible to determine a precision in the radio altimetric altitude measurement. The precision of the probe performing the measurement of height Hm depends on the value of the measurement. This precision can be known by calibrating the radio altimetry means. By way of example, a precision of the order of 2% is commonly obtained for a height Hm of less than 1000 feet.

Advantageously, a weighted altitude Zh is determined, dependent on the altitudes Zv and Zr given by each means for determining the altitude and their relative precision denoted Pzv and Pzr respectively. For example, when the precisions of the two altitude determination means are of the same order of magnitude, the weighted altitude is equal to the mean of the altitudes determined by each of the means for determining the altitude.

Advantageously, the weighting takes account of the precision adopted for each means for determining the altitude. It is possible for example to define for each means for determining the altitude a precision level Pzv or Pzr that can vary from 1 to 9; 1 representing a high precision and 9 a low precision. The weighted altitude Zh will then be equal to:

Zh=(Zr/Pzr+Zv/Pzv)×(1/Pzr+1/Pzv)

It is possible not to take account of a measurement carried out by one of the means for determining the altitude if the precision of the measurement carried out by the other means for determining the altitude is markedly greater. For example, below 1000 feet, in the case where the signals received by the GPS system originate from only two satellites, only the altitude determined by the radio altimetry means is taken into account. It is of course understood that in the case of a differential GPS system, its precision remains very good for low altitudes, of the order of 10 feet. The weighted altitude calculation in the approach will then be retained up to landing.

As previously, the altitude Zh is converted into a weighted barometric altitude with a possible change of reference frame and a temperature correction to obtain a corrected weighted barometric altitude. Then, the corrected weighted barometric altitude is compared with a measured barometric altitude, and an alert is generated when the discrepancy between the corrected weighted barometric altitude and the measured barometric altitude exceeds a predefined value.

Advantageously, the predefined value is dependent on the precision of the altitude determination means adopted for calculating the weighted altitude Zh.

Advantageously, after generation of the alert, a setting value for the barometric altitude is proposed to the pilot of the aircraft making it possible to make the measured barometric altitude coincide with the determined barometric altitude. Thereafter, the pilot has the possibility of validating or otherwise this setting value. The pilot may possibly verify this value with an air traffic controller.

Advantageously, when the aircraft is descending, below a predefined altitude, of for example 500 feet, the setting value for the barometric altitude will have been sufficiently refined at a higher altitude and the pilot is sufficiently busy with the actions for the final approach as to no longer be involved with setting and the method freezes its calculations and generates no alert.

Advantageously, in the approach, the aircraft may receive data relating to the destination airport such as notably the local barometric setting, for instance the QNH. This information can travel through a digital link that is well known in the literature by the name “Digital Automatic Terminal Information Services (DATIS)”. It is possible to compare the local barometric setting transmitted in a digital manner with the actual setting aboard the aircraft and generate an alert when a difference between the local barometric setting transmitted and the actual setting exceeds a predefined value, for example 1 hPa. The pilot is then prompted to replace the actual setting value with the local barometric setting value transmitted. The pilot may or may not then validate this replacement.

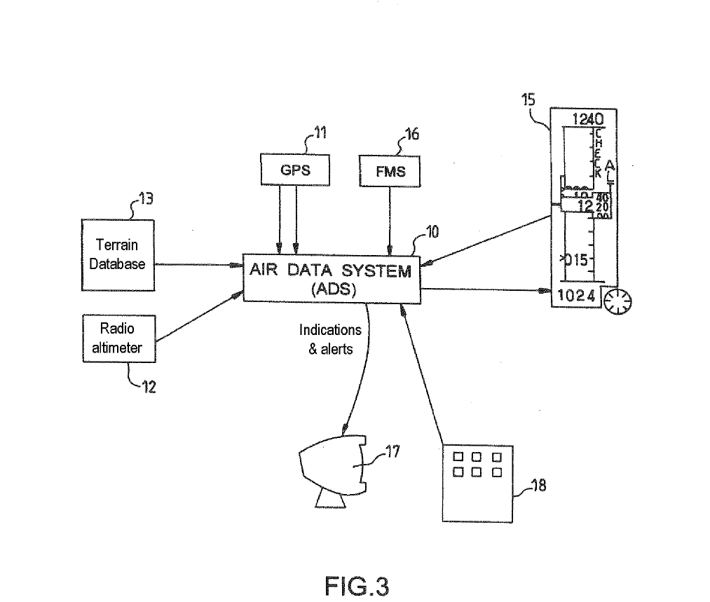

FIG. 3 represents a device making it possible to implement the invention. The method is implemented in a computer 10 called the ADS controlling the flight data and well known in the literature by the name “Air Data System”. The ADS computer 10 receives determined altitudes from two means for determining the altitude not using the barometric pressure such as a GPS system 11 and a radio altimeter 12, information relating to the altitude Zt of the terrain originating from a terrain database 13, a barometric altitude measured by an altimeter 14 whose display 15 is represented, information relating to the lateral position of the aircraft originating from the GPS system 11 and/or from a flight control computer 16 called the FMS and well known in the literature by the name “Flight Management System”. The ADS computer 10 is moreover linked to a display 17 making it possible to display the alert when the discrepancy between the determined altitude and a barometric altitude measured aboard the aircraft exceeds a predefined value, to the altimeter 14 to ascertain the actual setting of the altimeter, and to data entry means 18 allowing the pilot to validate the setting value making it possible to make the measured barometric altitude coincide with the determined altitude.

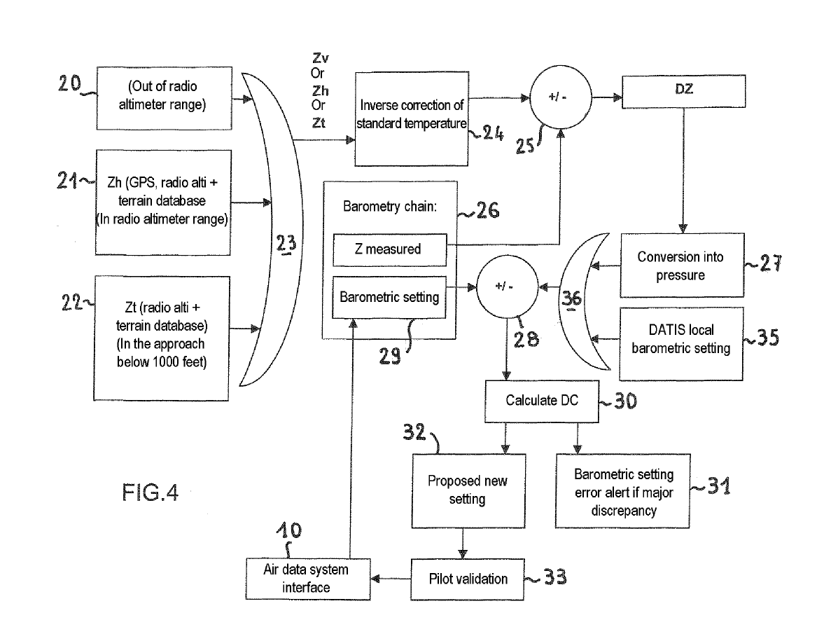

FIG. 4 represents in block diagram form an exemplary chaining of the operations of the method of the invention.

The determination of the altitude with the aid of a means for determining the altitude not using the barometric pressure is represented in boxes 20 to 22. Box 20 represents the determination of the altitude Zv by the GPS system when the aircraft is out of range of its radioaltimetry means. Box 21 represents the determination of the weighted altitude Zh at one and the same time by the GPS system and by the radioaltimetry means. Box 22 represents the determination of the altitude Zt solely by the radioaltimetry means. The altitude Zt only, without weighting with the altitude Zv, is taken into account only at low altitude, for example below 1000 feet, below which threshold it is considered that Zt has a markedly greater precision than the altitude Zv. Box 23 represents the act of choosing one of the three altitudes Zv, Zh or Zt as a function of their value and of their relative precision. Box 24 represents the correction of one of the three altitudes Zv, Zh or Zt as a function of temperature to obtain the corrected determined altitude Zi. The altitude Zi is thereafter compared in box 25 with an altitude measured by a barometric chain 26 comprising a static pressure tap for the air surrounding the aircraft. The comparison performed in box 25 makes it possible to determine a discrepancy DZ between the altitude Zi and the altitude measured by the barometric chain 26. The discrepancy DZ is thereafter converted, in box 27, into a pressure DP expressed in hPa. The pressure DP is thereafter compared in box 28 with the barometric setting value 29 input into the barometric measurement chain. This value is for example 1024 hPa as represented in FIG. 3. From the comparison between the pressure DP and the setting value, a difference in setting DC is calculated in box 30. If this difference DC is greater than a predetermined difference, an alert is generated in box 31. In parallel with the generation of this alarm, a new setting value is proposed in box 32 which is transmitted to the ADS computer 10 after validation in box 33 by the pilot of the aircraft. The computer 10 transmits the setting value validated by the pilot to the barometric chain 26 as replacement for the previously input setting value 29.

Advantageously, the comparison, carried out in box 28, of the barometric setting value 29 input can be made either with the pressure DP, as described above, or with the local barometric setting traveling through the DATIS digital link 35 when the setting is available. The choice between the pressure DP the local setting is represented in box 36. Usually, the local setting is favored when it is available.

It will be readily seen by one of ordinary skill in the art that embodiments according to the present invention fulfill many of the advantages set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

1. A method for aiding the setting of the barometric altitude of an aircraft equipped with a means for determining the altitude not using the barometric pressure, comprising:
determining with the aid of the means for determining the altitude an altitude and its relative precision,
comparing the determined altitude with a barometric altitude measured aboard the aircraft,
generating an alert when the discrepancy between the determined altitude and the measured barometric altitude exceeds a predefined value,
proposing a barometric altitude setting value.

2. The method as claimed in claim 1, wherein the comparison of the determined altitude with a barometric altitude measured aboard the aircraft gives a discrepancy, in that the discrepancy is compared with a barometric setting value to determine a difference in setting and wherein the alert is generated and a new setting value proposed if the difference in setting is greater than a predetermined difference.

3. The method as claimed in claim 2, wherein the discrepancy is converted into a pressure before being compared with the barometric setting value.

4. The method as claimed in claim 2, wherein the comparison of the barometric setting value input can be made either with the discrepancy or with a local barometric setting received from a destination airport.

5. The method as claimed in claim 1, the aircraft is equipped with two means for determining the altitude not using the barometric pressure and in that the determined altitude is a weighted altitude dependent on the altitudes given by each means for determining the altitude and their relative precision.

6. The method as claimed in claim 1, wherein after generation of the alert, a setting value is proposed to the pilot of the aircraft making it possible to make the measured barometric altitude coincide with the determined altitude, and wherein a pilot of the aircraft has the possibility of validating or otherwise the setting value.

7. The method as claimed in claim 6, wherein the setting value validated by the pilot is transmitted to the barometric chain as replacement for the previously input setting value.

8. The method as claimed in claim 1, wherein the setting of the barometric altitude is automatically modified when the discrepancy between the determined altitude and the measured barometric altitude exceeds a predefined value.

9. The method as claimed in claim 1, wherein a first means for determining the altitude comprises satellite navigation means.

10. The method as claimed in claim 5, wherein a second means for determining the altitude comprises radio altimetry means.

11. The method as claimed in claim 1, wherein the determined altitude is corrected as a function of temperature.

12. The method as claimed in claim 1, wherein the predefined value is dependent on the precision (Pzv, Pzr) of the means for determining the altitude.

13. The method as claimed in claim 1, wherein below a predefined altitude the method freezes its calculations and does not generate any alert.

14. The method as claimed in claim 3, wherein the comparison of the barometric setting value input can be made either with the discrepancy or with a local barometric setting received from a destination airport.

15. The method as claimed in claim 2, wherein after generation of the alert, a setting value is proposed to the pilot of the aircraft making it possible to make the measured barometric altitude coincide with the determined altitude, and wherein a pilot of the aircraft has the possibility of validating or otherwise the setting value.

16. The method as claimed in claim 3, wherein after generation of the alert, a setting value is proposed to the pilot of the aircraft making it possible to make the measured barometric altitude coincide with the determined altitude, and wherein a pilot of the aircraft has the possibility of validating or otherwise the setting value.

17. The method as claimed in claim 4, wherein after generation of the alert, a setting value is proposed to the pilot of the aircraft making it possible to make the measured barometric altitude coincide with the determined altitude, and wherein a pilot of the aircraft has the possibility of validating or otherwise the setting value.

18. The method as claimed in claim 5, wherein after generation of the alert, a setting value is proposed to the pilot of the aircraft making it possible to make the measured barometric altitude coincide with the determined altitude, and wherein a pilot of the aircraft has the possibility of validating or otherwise the setting value.

19. The method as claimed in claim 2, wherein the setting of the barometric altitude is automatically modified when the discrepancy between the determined altitude and the measured barometric altitude exceeds a predefined value.

20. The method as claimed in claim 3, wherein the setting of the barometric altitude is automatically modified when the discrepancy between the determined altitude and the measured barometric altitude exceeds a predefined value.
